(19) United States
(12) Patent Application Publication
(10) Pub. No.: US 2007/0265906 A1
(43) Pub. Date: Nov. 15, 2007

(54) Apparatus and method for setting design parameters

(76) Inventor: Michael Neal, Moosic, PA (US)

Correspondence Address: L. ZALE PATENT LAW OFFICE, 334 SOUTH FRANKLIN ST., WILKES-BARRE, PA, 18702, US

(21) Appl. No.: 11/432,427

(22) Filed: May 10, 2006

(51) Int. Cl. G06F 17/30

(52) U.S. Cl. 705/10

(57) ABSTRACT

An objective system and method for determining design parameters for a proposed product functions to receive input from consumers to determine their preferences. The system also interacts with the consumer to determine the limit as to which they could no longer differentiate between two images differing slightly in a continuous parameter. The consumer preferences are graphed on a histogram in which peaks are identified and their values on the design parameter axis are noted. These values are potential design parameter values for product offerings. The relative areas under each of the different peaks indicates their relative popularity, and hence the relative number of products to be manufactured. The limit of consumers' perception or ‘Resolution Limits’ are graphed on a histogram. The range of the design parameter which equates to a given percentage of the population under the Resolution Limit Histogram is used as a tolerance limit in the manufacture of the proposed product.

### CROSS REFERENCE TO RELATED APPLICATIONS

This application is related to, U.S. patent application Ser. No. 10/938,868 “Method of Interactive System for Previewing and Selecting Eyeware” filed Sep. 13, 2004; Ser. No. 60/659,605 “Virtual Monitor System Having Lab-Quality Color Accuracy”, filed Mar. 7, 2005; Ser. No. 60/663,967 “Personal, Interactive Education and Advertising System” filed Mar. 18, 2005 and Ser. No. 60/675,676 filed Apr. 27, 2005 “Apparatus and Method for Setting Design Parameters” all by Dr. Michael R. Neal.

### BACKGROUND OF THE INVENTION

1. Field of the Invention

The present invention relates to a system for selecting manufacturing design parameters and more specifically to a system for selecting manufacturing design parameters in an objective fashion.

2. Discussion of Related Art

In manufacturing products, manufacturers are required to arbitrarily select many design parameters. For example, in the manufacture of colored contact lenses, design parameters such as color are arbitrarily set, then adjusted by subjective means. The color of a new contact lens intended to be offered as a product may initially be determined by a designer's perception of what is aesthetically pleasing. At some later time, the manufacturer may randomly adjust the color in an attempt to increase sales.

This method results in arbitrary product design which may result in lower sales and higher sales costs compared with an objectively designed, targeted product.

Currently, there is a need to define and adjust design parameters for products in a more objective fashion.

### SUMMARY OF THE INVENTION

The present invention may be embodied as a method of determining optimum product design values for a visually perceivable design parameter of a product, comprising the steps of:
a. choosing a target percentage of a population of customers for which said product is targeted;
b. displaying a plurality of images having varying values of the design parameter to the customers;
c. receiving customer responses indicating preferred design parameter values;
d. graphing a histogram of the preferred design parameter values for a plurality of customers to provide peaks centered at various design parameter values, being the Collective Preference values;
e. displaying a plurality of images varying in values of the design parameter to customers;
f. receiving customer responses indicating differences between the images;
g. using the customer responses to identify a minimum change in design parameter values which the customer can perceive, being the Resolution Limit for each customer;
h. repeating steps “e”-“g” for a plurality of customers;
i. identifying a Collective Resolution Limit which is a design parameter value range which includes the Resolution Limit of the target percentage of the customers, indicating a range of design parameter value changes which would be unperceivable to a target percentage of the population of customers;
j. defining products having design parameter values spaced by more than the Collective Resolution Limit from each of the Collective Preference Centers.

The present invention may also be embodied as a method of determining maximum product tolerance values for a visually perceivable design parameter, comprising the steps of:
a. displaying a plurality of images varying in values of the design parameter to customers;
b. receiving customer responses indicating differences between the images;
c. using the customer responses to identify a minimum change in design parameter values which the customer can perceive, being the Resolution Limit for each customer;
d. repeating steps “a”-“c” for a plurality of customers;
e. identifying a Collective Resolution Limit which is a design parameter value range which includes the Resolution Limit of the target percentage of the customers, indicating a range of design parameter value changes which would be unperceivable to a target percentage of the population of customers;
f. defining product manufacturing tolerance value ranges for the design parameter being less than the Collective Resolution Limit.

The present invention may also be embodied as a system for objectively determining values of a design parameter of a product being designed, intended to retrofit an existing personal computer (PC) having a monitor for displaying images provided to it, and input devices capable of interacting with a consumer to receive the responses from a consumer, including software capable of running on the PC, the PC and software together being adapted to:
a. provide images varying slightly in said design parameter to said monitor,
b. prompt said consumer to differentiate between images, and receive responses from the consumer,
c. calculate a Resolution Limit for the consumer based upon the responses of the consumer;
d. send the Resolution Limit and other information relating to the consumer to a host computer which used this information to determine values of the design parameter.

### OBJECTS OF THE INVENTION

It is an object of the present invention to use customer feedback to select the optimum design parameters for products being developed.

It is another object to the present invention to use statistical analysis on customer feedback to minimize the number of products offered while maximizing sales of the products offered.

It is another object of the present invention to reduce development costs of designing a new product.

It is another object to the present invention to reduce logistical costs involved in selling a newly designed product.

### BRIEF DESCRIPTION OF THE DRAWINGS

A complete understanding of the present invention may be obtained by reference to the accompanying drawings, when considered in conjunction with the subsequent detailed description, in which:

FIG. 1 is an illustration of one embodiment consistent with the present invention.

FIGS. 2a and 2b together are a flowchart describing the functioning of the present invention.

FIG. 3 is a screen shot of the monitor of FIG. 1.

FIG. 4 is a histogram of a population's color preferences.

FIG. 5 is a histogram of a population's ability to resolve different colors.

### DETAILED DESCRIPTION OF THE PRESENT INVENTION

Design Parameters

The present invention is aimed at determining values of design parameters which are variables and which can be visually perceived. There are many such design parameters which must be determined before manufacturing a product. For example in the manufacture of colored contact lenses, parameters such as the base color of the lens, the outer diameter of the colored iris, the pupilary size, the granularity of an overlay pattern, the color differences between the contact base color and a pattern color, angular offsets between two patterns, and linear offsets between two patterns, and the number of layers of a lens having color or patterns. Since color contact lenses are primarily used for cosmetic purposes, the invention will be described in the context of determining the color design parameter.

Color at a point is defined as the set of amplitudes of each visible light wavelength across the visible light spectrum. By indicating that an object is blue merely means that it has amplitudes which have a major peak in the blues wavelengths. Therefore, it is theoretically possible to have an infinite number of different spectra that each peak in the blue wavelengths, and therefore an infinite number of blues.

Since a manufacturer may only market several different colors of the infinite set of possible colors, one must make design decisions. The present invention aids in objectively selecting design parameters which will most closely match the needs of a large portion of the targeted population.

Design Considerations

Manufacturing of certain items can become very expensive if the tolerances in the manufacturing process are very small. For example, ball bearings which must be manufactured within 0.001 mm. of a specified diameter may cost many times more than ball bearings which can be manufactured within 0.1 mm. of the same specified diameter.

Therefore, if the manufacturer were to use the bearings having the 0.001 mm. tolerance in applications where the other ball bearings would cause no perceivable differences in function, the product would be over designed. This would not be a cost-efficient method for manufacturing the product.

Manufacturers also try to position products to cover a range of needs. By offering a multitude of products, the manufacturer has a greater chance of having an offering meeting the needs of a potential buyer.

However, the costs involved in having many different manufacturing lines, keeping track of many different orders, and warehousing many different products becomes considerable. Therefore, there is a cost savings in reducing the number of products manufactured, warehoused and offered for sale.

The more products that are offered, the greater the possibility that there will be a product which meets the needs of a potential customer. Therefore, tradeoffs exist between the number of products offered, the cost of offering these products, and the income derived from the sale of these products.

Therefore, it would be advantageous to offer products where there is the greatest need, while omitting products having the lowest potential for sales.

Apparatus

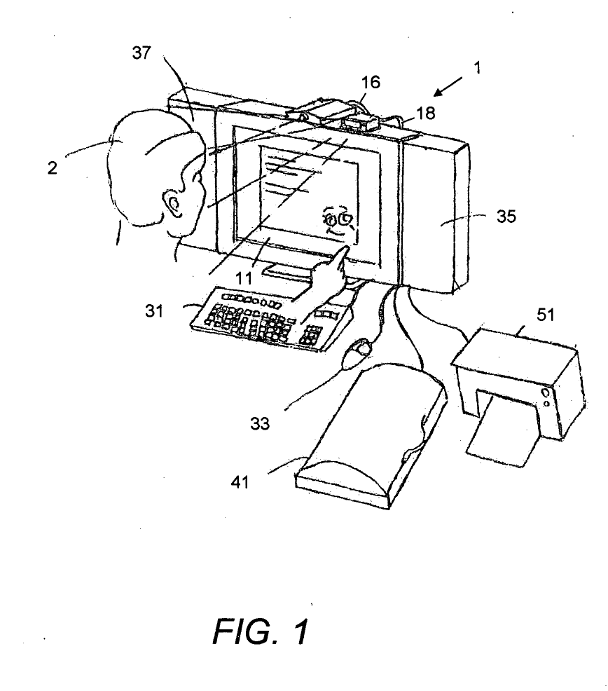

Much of the equipment used is described in “Cross References to Related Applications” above. In FIG. 1 system 1 then interacts with consumer 2 to allow consumer 2 to modify the displayed image. This may include changing contact lens color. The modified images are color adjusted to display color-accurate images to consumer 2. System 1 then displays the modified image back to consumer 2 on monitor 11. The system may use other input devices, such as a scanner 41 and other output devices such as a printer 51, provided that they are calibrated and corrected for color deviations as set forth in the U.S. patent application Ser. No. 60/659,605 “Virtual Monitor System Having Lab-Quality Color Accuracy”, filed Mar. 7, 2005, and Ser. No. 11/368,989 “Virtual Monitor System Having Lab-Quality Color Accuracy”, filed Mar. 6, 2006.

In an alternative embodiment, a camera 12 may be used with specialized lighting units 35, 37 which emit a desired spectral output.

Camera 12 acquires an image of the consumer 2 in this lighting. An internal processor of system 1 runs software designed to correct the color of the image. These images will be used by the system in place of pre-stored images for the remaining processing.

System Prompts

Monitor 11 is also capable of producing text, audio, video, computer prompts, etc. to consumer 2. Monitor 11 and/or input devices 31, 33 may also be used to receive input from consumer 2. This consumer input may be text, button selection or indications of other actions of consumer 2 including time parameters.

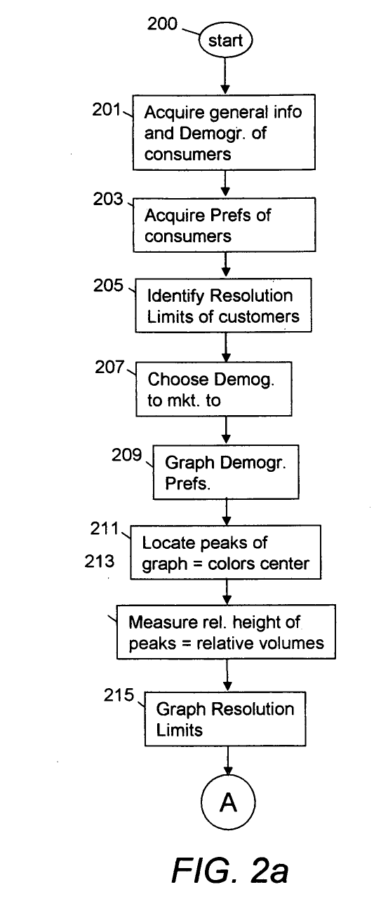

It would be best to describe the present invention in connection with the apparatus of FIG. 1 and a flow chart of its functioning shown in FIGS. 2a and 2b.

The process begins at step 200. In step 201 general information is solicited from the consumers on screen 11 of system 1 allowing the consumers to provide their input either through input devices 31 and 33 or a touch sensitive screen 11. This information may cover categories used to segment the population into groupings. These groupings may be by occupation type, age, type of contacts they wear, skin tone, eye color, or other factors.

Groups identified or segmented by one or more of these factors are called a ‘Demographic Group’ or simply a ‘Demographic’.

Taking again our example of the design of contact lenses, it is very important to not only know the preferences of the consumer, but also to know the demographics of the consumer.

In step 203 the Preference of a population of consumers regarding a continuous design variable, here being color, are acquired.

This information may be acquired using a single image

Acquire Consumer Preferences on Given Parameters

Single Image

One possible embodiment is to provide a consumer preference rating system. Image information is provided to consumer 2, preferably on monitor 11. Consumer 2 is then questioned regarding the image. For example, consumer 2 will be prompted to rate the image on a scale from 1 to 10, with 10 being the most desirable. This may be run several times, and the answers stored along with an indication of the image.

Similar information may be obtained in step 203 using multiple images.

Multiple Images

Another method of obtaining information from consumer 2 operates to display more than one image simultaneously on monitor 11, and then to solicit input from consumer 2. These images may be questions of a relative nature, such as requesting consumer 2 to determine which of the several images is most pleasing. By successively quizzing consumer 2 and by displaying different combinations of images, the consumer 2's selections can be determined with a great deal of accuracy.

Manual Parameters Adjustment

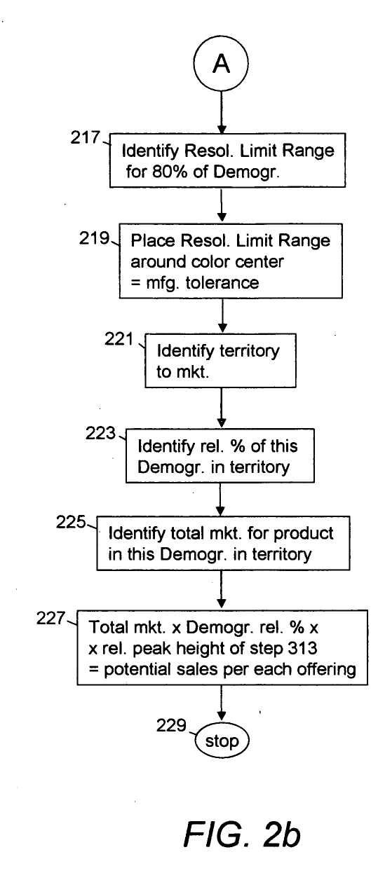

The information may be acquired using manual parameters adjustments, using sliders, as shown in FIG. 3. Using the example of designing values for continuous parameters for the manufacture of contact lenses, FIG. 3 illustrates an image 301 displayed on monitor 11. Image 301 is a color-accurate image showing the consumer with the chosen set of colored contacts over their irises.

A plurality of sliders 303, shown here as software images on the monitor 11, may represent a parameter to be adjusted, or elements of parameters to be adjusted by consumer 2. For example, the first few sliders 303 from the left each represent a frequency band of a base color spectrum of the contact lens, with the next few representing brightness and opacity. The resulting visual representation is shown in image 301. The consumer has the ability to move the sliders up or down thereby changing the values of the design parameters of the contact lenses in image 301. Therefore, the consumer may adjust these until an optimum point is reached.

In another example, the system may be used to determine design parameters for a cosmetic, such as lipstick. Several sliders 303 may represent components of color while others represent surface gloss, sparkle and transparency.

The system not only monitors the end results but also may monitor how each slider 303 is changed by the consumer over time. This time parameter may be important information later in the analyzing how each consumer tries to adjust the parameter values.

Since the consumer's preferences are to be tested, a consumer 2 is presented with output on monitor 11, and is requested to provide feedback regarding their preferences using the methods described above.

The preferences of a number of consumers 2 of different demographics are analyzed to produce a distribution of preferences.

The preferences of each consumer are stored separately since the preferences are intended to be correlated with the other information of the consumer.

In step 205 is determined how closely spaced the product offerings should be on the color continuum.

Identify Resolution Limits

The present invention also attempts to determine how much variation in a design parameter a consumer (or a population of consumers) is able to perceive.

To test this, the single image method may be used in which a single image is provided on the screen followed by another image and consumer 2 is questioned to determine if one or more of the sequential images is the same or different color. Consumer 2 will correctly differentiate between colors but eventually reach a Resolution Limit, which is a point which consumer 2 can no longer differentiate between the colors.

After this has been repeated several times with different sequences of images, the accuracy of the testing may be determined. If consumer 2 was providing random or inaccurate information, this consumer's information may be omitted and not used for further calculations.

Similarly, the Multiple Image method may be used in which more than one image is provided to consumer 2 and consumer 2 is asked to pick the colors which are the same. This may be repeated with different combinations of images each having different shades of a color to determine the accuracy of consumer 2's answers.

The slider method may also be used to determine the range of consumer 2's perceptions. In this case the target color may be shown on the screen, and consumer 2 is asked to change the sliders such that the color shown in image 301 matches that of the target color.

For accuracy, a different color (starting point) may be used with the same target color. The average deviation between the color the consumer has set and the target color will indicate consumer 2's resolution limit.

All of the data collected is stored along with its demographic information in a master database.

In step 207, demographics are determined identifying a population for which product offerings are to be designed. For example, this may be the population of consumers having a very light skin tone, and living in the Northeast US. The information relating to this information is extracted into a subset referred to as the ‘Demographic’ or the ‘Demographic Population’.

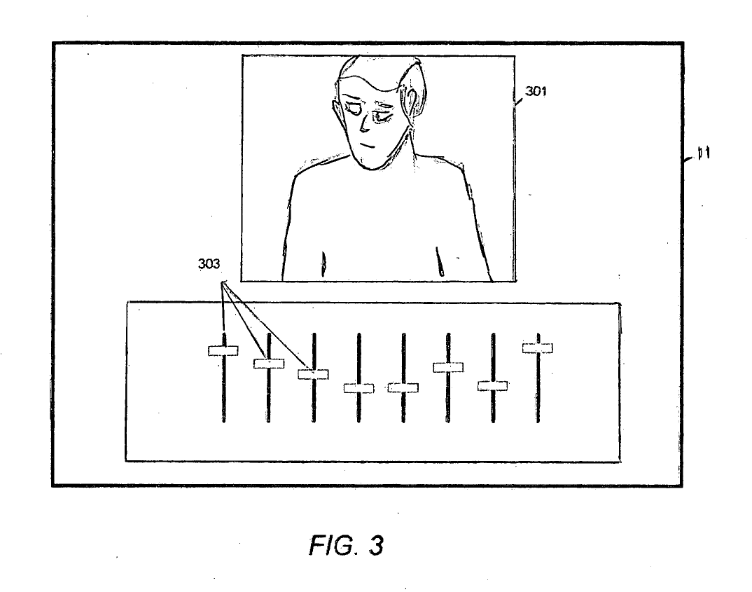

The color Preferences for this Demographic are graphed like a histogram in step 209 and is shown in FIG. 4.

This shows the color that is preferred on the horizontal axis graphed against the number of consumers of the Demographic selecting that color.

In step 211, the center of each of these peaks is identified and chosen. In FIG. 4 the peaks are at 590, 610, and 630 nm. These are all in the ‘blue’ region of the color spectrum. For our Demographic it appears that there are 3 potential colors which may be used for product offerings.

In step 213 the relative area under these peaks are 3, 2, 1 at 590, 610, 630 nm. respectively.

This shows that for our Demographic, the 590 nm blue contact is three times as popular as 630 nm blue contact.

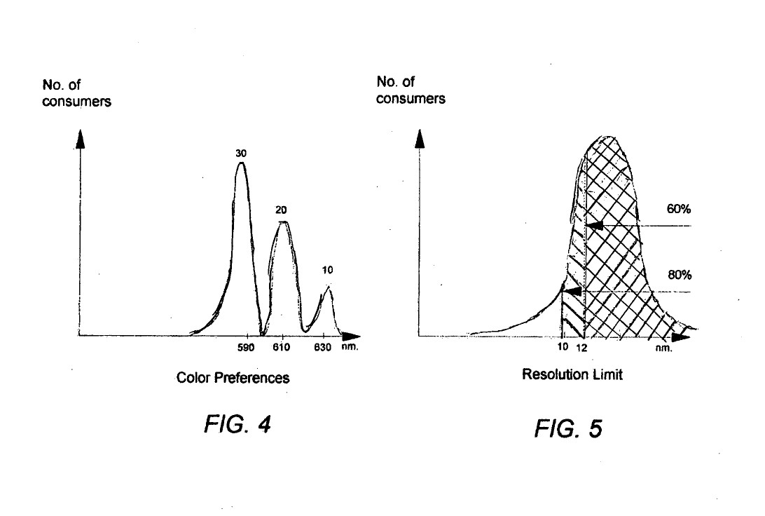

Similarly, in step 215 the resolution limits determined for the selected Demographic may be graphed in a histogram fashion and shown in FIG. 5.

FIG. 5 shows a sample distribution of minimum color differences perceived vs. number of consumers. For example, if it were determined that the smallest color difference that a consumer could identify which peak 12 nanometers or more apart on the color spectrum, this consumer's ‘Resolution Limit’ for this parameter would be 12 nanometer resolution for this color. By repeating this test for a number of consumers, a Collective Resolution Limit indicating a Resolution Limit of a portion of a population may be calculated.

For example, it may be determined that 60% of the total population (cross-hatched area) cannot detect color differences which are 12 nanometers or less apart. (40% can see the difference.) Therefore, for this color and population, a Collective Resolution Limit of 12 nanometers includes 60% of this population.

Similarly, if 80% of the population (cross-hatched and striped areas) cannot detect color differences being 10 nanometers or less apart, a Collective Resolution Limit of 10 includes 80% of this population. (Again, 20% can see the difference.)

In step 217, a designer determines the percentage of the Demographic that (s)he is targeting. 80% is used here as an example. Therefore, the Resolution Limit of 10 nm is selected. If a company were to offer two different contact lenses with colors being less than 10 nanometers apart in color, 80% of this population would consider these to be the same color and indistinguishable. This, therefore would add costs for having two products with all of the additional costs of requiring a different manufacturing line, advertising, warehousing, and related internal expenses, where the second product really is unnecessary.

Based upon our Demographics and assumptions it appears that our product offering would be three colored contacts with the color centered at a 590, 610 and 630 nm. The manufacturing tolerance would be set in step 219 to be less than 10 nanometers, or plus/minus 5 nm. This therefore allows the first contact lens to have a color ranging from 585-595 nm.

Similarly the second contact lens offering could have a manufacturing tolerance from 605-615 nm, with the third contact lens having manufacturing tolerances from 625-635 nm.

We also know from the data that the production of the 590 nm. contact lenses should be approximately 300% of that of the 630 nm. contact lenses and 150% of the 610 nm. contact lenses.

One may take this process a step further and identify the actual territory in which they intend to market in step 221.

In step 223 it is determined what the relative percentage of the population in the territory has the same demographics as those for which we have designed.

In step 225 is determined what the total market is in the territory for contact lenses.

In step 227 the total market determined in step 225 is multiplied by the relative percentage of the population determined in step 223, then by each of the relative peak areas illustrated in FIG. 4. This results in potential sales volume of each of the three different product offerings.

The process ends at step 229.

Other Design Parameters

Even though the above discussion dealt primarily with the design parameter of contact lenses being color, other parameters affecting the appearance of the product may also be analyzed as described above.

These parameters may be the iris size, the size of non-colored section overlying the pupil, the number of layers of color, lined patterns which overlay color sections, the relative angular offset of two or more overlaid patterns, and the change in the degree of transparency moving in a radial direction across a contact lens, and other parameters.

By implementing the present invention on these and other parameters one may quickly and objectively determine the optimum product placement, thereby minimizing overhead costs and maximizing sales.

Home Use Kit

In an alternate embodiment of the present invention, a home use kit is shipped to the residence of many consumers. It is then employed to collect information from the population of consumers at their home locations. It employs items described above, described in the R&D LensCam case, and FIG. 1.

The home-use device includes software intended to run on a home PC that performs the functions of prompting the consumer with a pre-stored single image, multiple images or a manual input screen to allow the consumers to view prompts and provide the consumer input.

The software is further differentiated to collect the consumer input information and send it back to a base computer via e-mail or on the Internet. The base computer then collects the information from a number of consumers and performs the statistical functions discussed above.

In an alternative embodiment of the present invention, a controlled lighting source 35, 37 having a specific illumination spectrum as defined in the R&D LensCam case referenced above, is employed. This embodiment also includes a camera 12 which takes a digital image and stores it. The system then shows the images from camera 12 to the consumer in place of the pre-stored images.

While several presently preferred embodiments of the novel invention have been described in detail herein, many modifications and variations will now become apparent to those skilled in the art. It is, therefore, to be understood that the appended claims are intended to cover all such modifications and variations as fall within the true spirit of the invention.

What is claimed is:

1. A method of determining optimum product design values for a visually perceivable design parameter of a product, comprising the steps of:
a. choosing a target percentage of a population of customers for which said product is targeted;
b. displaying a plurality of images having varying values of the design parameter to the customers;
c. receiving customer responses indicating preferred design parameter values;
d. graphing a histogram of the preferred design parameter values for a plurality of customers to provide peaks centered at various design parameter values, being the Collective Preference values;
e. displaying a plurality of images varying in values of the design parameter to customers;
f. receiving customer responses indicating differences between the images;
g. using the customer responses to identify a minimum change in design parameter values which the customer can perceive, being the Resolution Limit for each customer;
h. repeating steps “e”-“g” for a plurality of customers;
i. identifying a Collective Resolution Limit which is a design parameter value range which includes the Resolution Limit of the target percentage of the customers, indicating a range of design parameter value changes which would be unperceivable to a target percentage of the population of customers;
j. defining products having design parameter values spaced by more than the Collective Resolution Limit from each of the Collective Preference Centers.

2. The method of claim 1, wherein the design parameter is a color parameter.

3. The method of claim 1, wherein the design parameter is a measure of an offset between at least two patterns.

4. The method of claim 1, wherein the design parameter is a rotational offset between at least two patterns.

5. The method of claim 1, wherein the design parameter is a linear offset between at least two patterns.

6. The method of claim 1, wherein the design parameters is the degree of opacity of a product.

7. A method of determining maximum product tolerance values for a visually perceivable design parameter, comprising the steps of:
a. displaying a plurality of images varying in values of the design parameter to customers;
b. receiving customer responses indicating differences between the images;
c. using the customer responses to identify a minimum change in design parameter values which the customer can perceive, being the Resolution Limit for each customer;
d. repeating steps “a”-“c” for a plurality of customers;
e. identifying a Collective Resolution Limit which is a design parameter value range which includes the Resolution Limit of the target percentage of the customers, indicating a range of design parameter value changes which would be unperceivable to a target percentage of the population of customers;
f. defining product manufacturing tolerance value ranges for the design parameter being less than the Collective Resolution Limit.

8. The method of claim 7, wherein the design parameter is a color parameter.

9. The method of claim 7, wherein the design parameter is a measure of an offset between at least two patterns.

10. The method of claim 7, wherein the design parameter is a rotational offset between at least two patterns.

11. The method of claim 7, wherein the design parameter is a linear offset between at least two patterns.

12. The method of claim 7, wherein the design parameters is the degree of opacity of a product.

13. A system for objectively determining values of a design parameter of a product being designed, intended to retrofit an existing personal computer (PC) having a monitor for displaying images provided to it, and input devices capable of interacting with a consumer to receive the responses from a consumer, including software capable of running on the PC, the PC and software together being adapted to:
a. provide images varying slightly in said design parameter to said monitor,
b. prompt said consumer to differentiate between images, and receive responses from the consumer,
c. calculate a Resolution Limit for the consumer based upon the responses of the consumer;
d. send the Resolution Limit and other information relating to the consumer to a host computer which used this information to determine values of the design parameter.

14. The system of claim 13 further comprising a host computer for receiving the Resolution Limit of a plurality of other consumers adapted to:
a. determine a Collective Resolution Limit which will include Resolution Limits of a predefined percentage of the consumers, and
b. set values of the design parameter for new products having a minimum value spacing at least as large as the Collective Resolution Limit.
